(19) United States
(12) Patent Application Publication
(10) Pub. No.: US 2015/0205756 A1
(43) Pub. Date: Jul. 23, 2015

(54) NUMERICAL INTEGRATION USING VARIATIONAL HOLDER'S INEQUALITY

(71) Applicant: Xerox Corporation, Norwalk, CT (US)

(72) Inventor: Guillaume M. Bouchard, Saint-Martin-Le Vinoux (FR)

(73) Assignee: Xerox Corporation, Norwalk, CT (US)

(21) Appl. No.: 14/159,498

(22) Filed: Jan. 21, 2014

(51) Int. Cl. G06F 17/10; G06N 7/00

(52) U.S. Cl. CPC G06F 17/10; G06N 7/005

(57) ABSTRACT

Given the integral Z:= [symbol] ƒ(t)g(t)dv(t) of the product of two functions ƒ and g defined on a space [symbol] , a pivot function r: [symbol] [symbol] [symbol] ⁺ is optimized to minimize the bound defined by the inequality

$$Z \leq {( {\int }_{𝒥} {f ( t )}^{p} {r ( t )}^{p} d v ( t ) )}^{\frac{1}{p}} {( {\int }_{𝒥} {g ( t )}^{q} {r ( t )}^{- q} d v ( t ) )}^{\frac{1}{q}}$$

where v is a measure on the space [symbol] , p≧1 and

$$\frac{1}{p} + \frac{1}{q} = 1$$

to determine an optimized pivot function rₒₚₜ(t). The product ƒg may be evaluated as ƒg=ƒ^{p}rₒₚₜ^{p} or ƒg=g^{q}rₒₚₜ^{-q}. The integral Z:= [symbol] ƒ(t)g(t)dv(t) may e evaluated as the product

$${( {\int }_{𝒥} {f ( t )}^{p} {r ( t )}^{p} d v ( t ) )}^{\frac{1}{p}} {( {\int }_{𝒥} {g ( t )}^{q} {r ( t )}^{- q} d v ( t ) )}^{\frac{1}{q}}$$

with r(t)=rₒₚₜ(t). The method is suitably performed by an electronic data processing device. More generally, an integral Z:= [symbol] Πₖ₌₁^{K}ƒₖ(t)dv(t) where K≧2 may be evaluated by optimizing a pivot function q(t)=Πₖ₌₁^{K}qₖ(t) to minimize a bound defined by the inequality

$${\int }_{𝒥} {\prod }_{{k}^{′} = 1}^{K} {f}_{k} ( t ) d v ( t ) \leq {\prod }_{k = 1}^{K} {( {\int }_{𝒥} {( \frac{{f}_{k} ( t )}{{q}_{k} ( t )} )}^{\frac{1}{{ρ}_{k}}} {\prod }_{{k}^{′} = 1}^{K} {q}_{{k}^{′}} ( t ) d v ( x ) )}^{{ρ}_{k}}$$

where ρₖ≧0 for k=1, . . . , K and Σₖ₌₁^{K}ρₖ=1 to determine an optimized pivot function qₒₚₜ(t).

### BACKGROUND

The following relates to the information processing arts, computational arts, numerical integration arts including inference arts such as Bayesian inference, and related arts.

Tasks such as machine learning, modeling, and so forth commonly involve evaluation of an intractable sum or integral. For example, in Bayesian inference a posterior predictive distribution of the form:

p(x|,α)=∫_{Θ}p(x|θ)p(θ|X,α)dθ

is evaluated, where θ is a parameters vector defined on the parameter space Θ, α is a hyperparameter vector, X is a training data set (also called the “evidence”), and x is a data point to be predicted. Computing the posterior predictive distribution requires evaluating an integral of a product of two functions, namely p(x|θ) and p(θ|X,α), which is often not possible to perform analytically.

Numerical approximations methods have been derived to evaluate such integrals. Sampling techniques such as Gibbs sampling are sometimes used to explore the space and compute sufficient statistics to estimate such an integral. However, sampling techniques are stochastic by nature and typically do not provide guaranteed convergence, but only convergence with a high probability. Other approaches minimize an objective function, such as a loss function, a negative log-likelihood or a energy criterion.

In some approaches, an upper (or lower) bounding function is defined such that the integral is known to be less than (or greater than) the bound everywhere over the region of interest. In such approaches, the “tightness” of the bound determines accuracy of (or at least an error bar for) the estimated integral. A loose bound which has large gaps between the bounding function and the true integral over the region will typically result in a large overestimate of the integral (for an upper bound). A tight bound of the bounding function to the true integral over the region provides accuracy and a small error bar.

Accuracy can be improved by partitioning the region over which the integral is to be computed and defining an upper (or lower) bound for each partition. Bouchard et al., U.S. Pat. No. 8,190,550 titled “Split Variational Inference” discloses some such approaches, including a disclosed embodiment which partitions a region of interest into a plurality of soft bin regions that span the region of interest, estimates an integral over each soft bin region of a function defined over the region of interest, and outputs a value equal to or derived from the sum of the estimated integrals over the soft bin regions spanning the region of interest.

### BRIEF DESCRIPTION

In some embodiments disclosed herein, a non-transitory storage medium storing instructions readable and executable by an electronic data processing device to perform a method of evaluating an integral Z:= [symbol] Πₖ₌₁^{K}ƒₖ(t)dv(t) where K≧2, v is a measure on a space [symbol] and ƒₖ(t), k=1, . . . , K are functions defined in the space [symbol] , the method comprising operations including optimizing a pivot function q(t)=Πₖ₌₁^{K}qₖ(t) to minimize a bound defined by the inequality [symbol] Π_{k′=1}^{K}ƒₖ(t)dv(t)≧Πₖ₌₁^{K}

$${( {\int }_{𝒥} {( \frac{{f}_{k} ( t )}{{q}_{k} ( t )} )}^{\frac{1}{{ρ}_{k}}} {\prod }_{{k}^{′} = 1}^{K} {q}_{{k}^{′}} ( t ) d v ( x ) )}^{{ρ}_{k}}$$

where ρₖ≧0 for k=1, . . . , K and Σₖ₌₁^{K}ρₖ=1 to determine an optimized pivot function qₒₚₜ(t) and optimized values ρ₁_{ₒₚₜ}, . . . , ρ_{K}_{ₒₚₜ}, and evaluating Z as the product

$${\prod }_{k = 1}^{K} {( {\int }_{𝒥} {( \frac{{f}_{k} ( t )}{{q}_{k} ( t )} )}^{\frac{1}{{ρ}_{k}}} {\prod }_{{k}^{′} = 1}^{K} {q}_{{k}^{′}} ( t ) d v ( x ) )}^{{ρ}_{k}}$$

with q(t)=qₒₚₜ(t) and ρₖ=ρₖ_{ₒₚₜ} for k=1, . . . , K.

In some embodiments disclosed herein, an apparatus comprises a non-transitory storage medium as set forth in the immediately preceding paragraph and an electronic data processing device configured to read and execute the instructions stored on the non-transitory storage medium.

In some embodiments disclosed herein, a method operating on two functions ƒ and g each mapping from a space [symbol] into [symbol] ⁺ comprises optimizing a pivot function r: [symbol] [symbol] [symbol] ⁺ to minimize a bound defined by the inequality Z≦

$${( {\int }_{T} {f ( t )}^{p} {r ( t )}^{p} d v ( t ) )}^{\frac{1}{p}} {( {\int }_{T} {g ( t )}^{q} {r ( t )}^{- q} d v ( t ) )}^{\frac{1}{q}}$$

where v is a measure on the space [symbol] and p≧1 and

$$\frac{1}{p} + \frac{1}{q} = 1$$

to determine an optimized pivot function rₒₚₜ(t). The method may further comprise evaluating the product ƒg as one of ƒg=ƒ^{p}rₒₚₜ^{p} and ƒg=g^{q}rₒₚₜ^{-q}. The method may additionally or alternatively further comprise evaluating the integral Z:= [symbol] ƒ(t)g(t)dv(t) as the product

$${( {\int }_{T} {f ( t )}^{p} {r ( t )}^{p} d v ( t ) )}^{\frac{1}{p}} {( {\int }_{T} {g ( t )}^{q} {r ( t )}^{- q} d v ( t ) )}^{\frac{1}{q}}$$

with r(t)=rₒₚₜ(t). The method is suitably performed by an electronic data processing device.

### BRIEF DESCRIPTION OF THE DRAWINGS

FIG. 1 diagrammatically shows an electronic data processing device configured to perform a variational Hölder's inference technique disclosed herein.

FIGS. 2 and 3 plot examples of truncated Gaussian integration performed using the variational Hölder's inference technique.

### DETAILED DESCRIPTION

In existing integral evaluation approaches employing an upper (or lower) bound, a problem exists in that substantial computer resources are required to evaluate the integral. The evaluation of the integral is computationally expensive due to the need to determine a tight bound. In approaches employing partitioning of the region of interest, the number of computations is multiplied by the number of partitions.

Disclosed herein are improved systems and methods providing various benefits, such as: reduced computer resources required for evaluating the integral; more accurate integration; and applicability to a wide range of classes of integrals in which the integrand can be formulated as the product of two or more functions each of which is individually readily integrable. The disclosed systems and methods additionally or alternatively may be employed to estimate the normalized integrand distribution.

The disclosed approaches for computationally efficient integral evaluation are based on Hölder's inequality, which was originally promulgated by Otto Ludwig Hölder (Dec. 22, 1859-Aug. 29, 1937). Hölder's inequality is suitably defined as follows. Denote by ƒ and g two functions mapping from a space [symbol] into [symbol] ⁺. For example, in a probabilistic inference problem, the functions ƒ and g typically correspond to the prior and the likelihood term of the probabilistic inference problem. The integral Z of a product ƒg of these functions is to be evaluated, that is, Z:=∫ [symbol] ƒ(t)g(t)dv(t), where v is a measure on the space [symbol] . It is assumed that this integral Z is intractable (or at least is not readily evaluated analytically). However, the individual integrals are readily integrated, that is, there exist efficient methods to compute the individual integrals ∫ [symbol] ƒdv and ∫ [symbol] gdv. A known upper bound on the integral Z is the Hölder inequality, which can be written as follows:

$$Z \leq {( {\int }_{T} {f ( t )}^{p} d v ( t ) )}^{\frac{1}{p}} {( {\int }_{T} {g ( t )}^{q} d v ( t ) )}^{\frac{1}{q}} \qquad ( 1 )$$

where p is a scalar and p≧1 and q is defined in terms of p as

$$\frac{1}{p} + \frac{1}{q} = 1.$$

Hölder's inequality (e.g. as expressed in Equation (1)) might appear to be a good candidate for evaluation of integrals such as integrals implicated in evaluating a posterior predictive distribution in Bayesian inference. However, in practice Hölder's inequality is often not useful for such purposes because the bound is too loose. Hölder's inequality provides a tight bound when g=ƒ^{p-1} (or equivalently when ƒ=g^{q-1}), but in practical applications such as Bayesian inference this equality cannot be achieved for any value of p, and the bound is loose. Accordingly, Hölder's inequality is not of practical use in evaluating many integrals of the form Z:= [symbol] ƒ(t)g(t)dv(t).

Disclosed herein are integration approaches that are implementable with reduced computer resources (i.e. are less computationally expensive) as compared with other existing integration approaches. The disclosed integration approaches modify Hölder's inequality to incorporate a pivot function r as follows. For any function r: [symbol] [symbol] [symbol] ⁺ the following inequality holds:

$$Z \leq {( {\int }_{T} {f ( t )}^{p} {r ( t )}^{p} d v ( t ) )}^{\frac{1}{p}} {( {\int }_{T} {g ( t )}^{q} {r ( t )}^{- q} d v ( t ) )}^{\frac{1}{q}} . \qquad ( 2 )$$

This proposition is suitably demonstrated as follows. Replace ƒ by ƒr and similarly replace g by

$$\frac{g}{r}$$

in Hölder's inequality as presented in Equation (1). The expression for the integral Z is then written as:

$$Z = {\int }_{T} ( f ( t ) r ( t ) ) \frac{g ( t )}{r ( t )} d v ( t ) \qquad ( 3 )$$

Note that the integral Z of Equation (3) is exactly equal to the original integral Z:= [symbol] ƒ(t)g(t)dv(t) since the r(t) and

$$\frac{1}{r ( t )}$$

terms of Equation (3) cancel. Applying Hölder's inequality (Equation (1)) to the integral of Equation (3) yields:

$${\int }_{T} ( f ( t ) r ( t ) ) \frac{g ( t )}{r ( t )} d v ( t ) \leq {( {\int }_{T} {f ( t )}^{p} {r ( t )}^{p} d v ( t ) )}^{\frac{1}{p}} {( {\int }_{T} {g ( t )}^{q} {r ( t )}^{- q} d v ( t ) )}^{\frac{1}{q}} \qquad ( 4 )$$

which is Equation (2) since the left-hand size is exactly equal to Z.

Equation (2) is referred to herein as a “variational Hölder's inequality”, and serves as the basis for a variational inference algorithm disclosed in the following which comprises minimizing the bound defined by Equation (2) with respect to the pivot function r.

As an initial point, it is observed herein that the upper bound defined by the variational Hölder's inequality (Equation (2)) actually becomes exact if r is chosen to be proportional to r* which is defined as follows:

$${r}^{*} ( t ) := \frac{{g}^{\frac{1}{p}} ( t )}{{f}^{\frac{1}{q}} ( t )} ∀ t ∈ T , \qquad ( 5 )$$

That is, for r=cr* with c being a positive scalar and r* as defined in Equation (5), the variational Hölder's inequality of Equation (2) becomes an equality. This can be demonstrated as follows. For r=cr*, the first integral of the right-hand side of Equation (2) is

$${cZ}^{\frac{1}{p}}$$

because it integrates

$${f}^{p} ( {cr}^{*} ) = {c}^{p} {f}^{p - \frac{p}{q}} g = {c}^{p} {f}^{p - p ( 1 - \frac{1}{p} )} g = {c}^{p} fg .$$

Similarly, the second integral of the right-hand side of Equation (2) is

$$\frac{1}{c} {Z}^{\frac{1}{q}}$$

because

$${{g}^{q} ( {cr}^{*} )}^{- q} = \frac{1}{{c}^{q}} {g}^{q - q ( 1 - \frac{1}{q} )} {f}^{\frac{q}{p}} = \frac{1}{{c}^{q}} fg .$$

The product of these integrals is

$${cZ}^{\frac{1}{p}} \times \frac{1}{c} {Z}^{\frac{1}{q}} = Z .$$

It is also noted that for the case of p=q=2 (which satisfies the conditions p≧1 and

$$\frac{1}{p} + \frac{1}{q} = 1$$

required for Hölder's inequality), the function r* given in Equation (5) corresponds to the square root of the ratio between the two factors ƒ and g, that is,

$${r}^{*} = \sqrt{\frac{g}{f}} .$$

Equation (2) using a pivot function r=cr* with r* given in Equation (5) thus yields an exact evaluation of Z. In practice however, the integrals in Equation (2) formulated using r* as given in Equation (5) are typically not easier to evaluate than the original integral Z.

As further disclosed herein, computationally efficient evaluation of the integral Z using the variational Hölder's inequality of Equation (2) is achievable by defining a family of variational functions [symbol] ={r(•,θ),θεΘ} parameterized by θεΘ for which the integrals of the form:

$${I}_{f} ( θ ; p ) := {\int }_{𝒥} {( f ( t ) r ( t ; θ ) )}^{p} d v ( t ) and \\ {I}_{g} ( θ ; q ) := {\int }_{𝒥} {( \frac{g ( t )}{r ( t ; θ )} )}^{q} d v ( t ) \qquad ( 6 )$$

are tractable. Choosing the best function r(•,θ) in the family [symbol] is disclosed herein to significantly tighten the bound as compared with Hölder inequality (Equation (1)). In one suitable optimization formulation, the upper bound Ī:Θ [symbol] [symbol] ⁺ is minimized with respect to θ, p and q (where p and q are not independent but rather are constrained by p≧1 and

$$\frac{1}{p} + \frac{1}{q} = 1 ) ,$$

where:

$$log I ( θ ) := \frac{1}{p} log {I}_{f} ( θ ; p ) + \frac{1}{q} log {I}_{g} ( θ ; q ) \qquad ( 7 )$$

For variational functions r(•,θ) that are differentiable with respect to θ, the optimal parameters θ can be obtained using an optimization algorithm such as (by way of illustrative example) a standard gradient descent algorithm.

In some embodiments, the pivot functions r are chosen to be log-linear functions. Defining the feature function φ: [symbol] [symbol] Θ and assuming the space Θ is equipped with the dot-product operation, the following class of pivot functions is suitably employed:

r(t,θ)=e^{<θ,φ(t)>},θεΘ (8)

For log-linear functions r as defined in Equation (8), the bound Ī is log-convex and differentiable in θ. This can be shown as follows. The factors log I_{ƒ} (θ;p) and log I_{g}(θ; q) are log-sum-exp functions (logarithm of the integral of an exponential function) and therefore are convex in θ. Hence log Ī(θ)=log I_{ƒ}(θ;p)+log I_{g}(θ; q) is a sum of two functions which are convex in θ, so that Ī(θ) is log-convex. Because of this log-convex property, gradient descent algorithms are less subject to local minima. In practice, this means that complex initialization procedures are not required. In addition, the optimization is not restricted to generic gradient descent algorithms, but rather other optimization methods, tailored to specific problems can alternatively be employed. Furthermore, various available theoretical tools pertaining to convex optimization may be employed to analyze convergence properties. For example, it is expected that the objective function of Equation (7) with a log-convex pivot function as per Equation (8) can be solved in polynomial time using standard gradient descent algorithms.

Optimization of Equation (7) with a pivot of the form r(t,θ):=e^{θ}^{^{T}}^{φ(t)} using a gradient descent algorithm may, for example, employ the following. Equation (7) may be written as log Iₕ(θ;p):=log( [symbol] h(t)^{p}e^{pθ}^{^{T}}^{φ(t)}dv(t)), and its gradient ∇_{θ} log Iₕ(θ;p) as

$${∇}_{θ} log {I}_{h} ( θ ; p ) := \frac{p}{{I}_{h} ( θ ; p )} {\int }_{𝒥} φ ( t ) {h ( t )}^{p} {e}^{p {θ}^{T} φ ( t )} d v ( t )$$

which is p [symbol] _{h,θ,p}[φ(t)]. Similarly, the gradient ∇ₚ log Iₕ(θ;p) may be written as

$$\frac{1}{{I}_{h} ( θ ; p )} {θ}^{T} {\int }_{𝒥} φ ( t ) {h ( t )}^{p} {e}^{p {θ}^{T} φ ( t )} d v ( t ) + \frac{1}{{I}_{h} ( θ ; p )} {\int }_{𝒥}$$

log(h(t))h(t)^{p}e^{pθ}^{^{T}}^{φ(t)}dv(t) which is θ^{T} [symbol] _{h,θ,p}[φ(t)]+ [symbol] _{h,θ,p}[log h(t)].

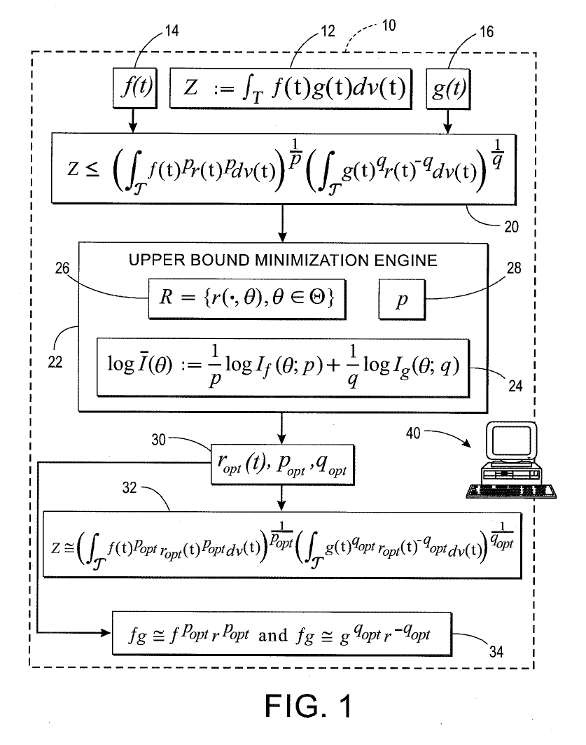

With reference to FIG. 1, a variational inference system 10 performs variational inference to compute an integral 12 (which is the integral Z given in Equation (1)) in which the integrand is a product of two functions ƒ 14 and g 16 by applying the variational Hölder's inequality 20 (which is Equation (2)). An upper bound minimization engine 22 optimizes an objective function 24 (which is the objective function given in Equation (7)) respective to pivot function parameters 26 (which are suitably the parameters θ of the family of variational functions [symbol] ={r(•,θ),θεθ}) and a variational Hölder's inequality parameter 28 (which is the scalar p in the illustrative system of FIG. 1; alternatively, the parameter may be q since p and q are related by

$$\frac{1}{p} + \frac{1}{q} = 1 ) .$$

The upper bound minimization engine 22 employs a suitable optimization algorithm, such as a gradient descent algorithm, to optimize the objective function 24 respective to the pivot function parameters 26 and Hölder's inequality parameter 28. Other optimization algorithms may be used. By way of an additional illustrative example, in some embodiments a modified gradient descent is employed in which only the pivot function parameters 26 are subject to optimization by the gradient descent algorithm while the Hölder's inequality parameter 28 can be optimized using a grid approach (e.g., repeating the gradient descent optimization of pivot function parameters θ for each of a plurality of discrete values of p and choosing the value of p yielding the best gradient descent result).

When employing log-linear functions r as defined in Equation (8), or another pivot function family for which the bound Ī is log-convex, it is ensured that a global upper bound minimum can be identified. Nonetheless, it is to be understood that as used herein the term “minimize”, “optimize” and similar phraseology encompasses iterative optimization techniques that are configured to settle on a local minimum that is not the global minimum, and/or that are configured to stop before reaching the precise global minimum. For example, the upper bound minimization engine 22 may employ an iterative optimization algorithm with stopping criteria that terminate the iterative process when the iteration-to-iteration change in the objective function value becomes less than a stopping threshold.

The output of the upper bound minimization engine 22 is a set of optimized parameters 30 including optimized pivot function parameters θₒₚₜ and optimized Hölder's inequality parameters pₒₚₜ and qₒₚₜ. Equation (2) is then applied using these optimized values to compute the integral 32 according to

$$Z ≅ {( {\int }_{𝒥} {f ( t )}^{{p}_{opt}} {{r}_{opt} ( t )}^{{p}_{opt}} d v ( t ) )}^{\frac{1}{{p}_{opt}}} {( {\int }_{𝒥} {g ( t )}^{{q}_{opt}} {{r}_{opt} ( t )}^{- {q}_{opt}} d v ( t ) )}^{\frac{1}{{q}_{opt}}} .$$

In addition to computing the integral of the distribution ƒ(t)_{g} (t) over the space [symbol] (that is, computing Z:= [symbol] ƒ(t)g(t)dv(t)), the foregoing approach is also optionally applied to compute the normalized distribution ƒ(t)g(t) itself. This is based on the recognition herein that obtaining an accurate upper bound to the log-partition is closely related to the fact that the approach provides a good approximation of the distribution and its moments. Hence, minimizing the variational Hölder inequality (Equation (2)) is also an efficient inference algorithm. To see this, the exact solution of Equation (5) is revisited. Recall that for r=cr* with c being a positive scalar and r* as defined in Equation (5), the variational Hölder's inequality of Equation (2) becomes an equality. In this case, the product ƒg can be approximated by ƒ^{p}r^{p} or g^{q}r^{-q} as:

ƒg=ƒ^{p}r^{p} or ƒg=g^{q}r^{-q} (9)

To see this, it is observed that Equation (5) leads to

$$r = {g}^{\frac{1}{p}} {f}^{- \frac{1}{q}} for r = {cr}^{*} .$$

By raising this equation to power p the expression

$${r}^{p} = {gf}^{- \frac{p}{q}} = ( gf ) \times {f}^{- \frac{p}{q} - 1}$$

is obtained, so that

$$fg = {r}^{p} {f}^{1 + \frac{p}{q}} = {r}^{p} {f}^{p}$$

because

$$1 + \frac{p}{q} = 1 + p ( 1 - \frac{1}{p} ) = p .$$

### Similarly,

$${g}^{q} {r}^{- q} = {fg}^{q - \frac{q}{p}} = {fg}^{q ( 1 - \frac{1}{p} )} = fg .$$

While this holds exactly only for r=cr* for which the inequality of Equation (2) is an equality, the relations of Equation (9) hold at least approximately where the bound is tight but not exact, for example when using the optimized bound provided by the optimized parameters 30. Thus, with reference again to FIG. 1, a normalized distribution 34, that is, the normalized distribution ƒ(t)g(t), is suitably computed using Equation (9) to yield ƒ(t)g (t)≅ƒ^{p}^{ₒₚₜ}(t)r^{p}^{ₒₚₜ}(t) or alternatively ƒ(t)g(t)≅g^{q}^{ₒₚₜ}(t)r^{-q}^{ₒₚₜ}(t).

The illustrative system of FIG. 1 is suitably embodied by a computer 40 or other electronic data processing device programmed to perform an embodiment of the disclosed variational inference algorithm, and/or by a non-transitory storage medium storing instructions executable by the illustrative computer 40 or other electronic data processing device to perform the disclosed variational inference algorithm. The non-transitory storage medium may, for example, comprise a hard disk or other magnetic storage medium, an optical disk or other optical storage medium, a random access memory (RAM), read-only memory (ROM), flash memory or other electronic storage medium, various combinations thereof, or so forth. The variational inference algorithm may be logically configured in various ways, such as being configured as a library integration function receiving as input the functions 14, 16 and optionally other user-configurable inputs such as the choice of pivot function family 26, a selection input that selects the output as the integral 32 or the normalized distribution 34, or so forth. The variational inference algorithm may alternatively be logically configured as an integral component of a process utilizing the integral, such as being the integral evaluation component of a Bayesian inference program or library function.

Some illustrative applications of the integral evaluation system of FIG. 1 and variants thereof are next described.

One illustrative application is evaluation of the product of univariate factors with a Gaussian. Using notations previously set forth, the function ƒ(t)=Πᵢ₌₁ⁿƒᵢ(tᵢ) is defined, where each function ƒᵢ: [symbol] [symbol] [symbol] is univariate. The function g(t) is also defined, with

$${e}^{- \frac{1}{2}} {t}^{T} At + {b}^{T} t$$

where A is a definite symmetric n×n matrix and bε [symbol] ⁿ. The Lebesgue measure is used for the measure v. The integral to be evaluated is:

$$I := {\int }_{{ℝ}^{n}} {\prod }_{i = 1}^{n} {f}_{i} ( {t}_{i} ) {e}^{- \frac{1}{2} {t}^{T} At + {b}^{T}} d t \qquad ( 10 )$$

This type of integral is used in certain machine learning tasks, and typically corresponds to the marginal data probability—that is, the evidence—of a linear regression model with known variance and sparse priors, n being the number of variables. Up to an affine change of variable to obtain orthogonal univariate factors, this integral corresponds also to the data evidence in a generalized linear model with Gaussian prior, where n is the number of independent observations. The functions ƒ and g alone are readily integrated, and remain readily integrated when multiplied by a Gaussian potential with diagonal covariance matrices, so that the following variational family is suitable for constructing the variational inference problem:

$$= \{ r ( t ; θ ) := {e}^{- \frac{1}{2} {t}^{T} diag ( {θ}_{1} ) t + {\tilde{θ}}_{2}^{T} t} , θ = {( {θ}_{1}^{T} , {θ}_{2}^{T} )}^{T} , {θ}_{1} ∈ {ℝ}^{n} , {θ}_{2} ∈ {ℝ}^{n} \} \qquad ( 11 )$$

A approximation to the integral of Equation (10) is obtained by minimizing the upper bound Ī given in Equation (7) using the system of FIG. 1.

Integration of the orthogonal univariate function is first considered. Here the first term I_{ƒ} required to compute the bound can be obtained efficiently in terms of univariate integrals:

$${I}_{f} ( θ ; p ) = {\prod }_{i = 1}^{n} {\int }_{ℝ}^{ } {f}_{i}^{p} ( {t}_{i} ) {e}^{p ( - \frac{{u}_{1 i} {t}_{i}^{2}}{2} + {u}_{2 i} {t}_{i} )} d {t}_{i} = {\prod }_{i = 1}^{n} {U}_{[ {f}_{i} ]} ( {u}_{1 i} , {u}_{2 i} , p ) \qquad ( 12 )$$

where the univariate integrals U_{[h]}: [symbol] ²×[01] [symbol] [symbol] are defined as:

$${U}_{[ h ]} ( α , β , p ) := {\int }_{ℝ}^{ } {( h ( t ) {e}^{- \frac{1}{2} α {t}^{2} + β t} )}^{p} d {t}_{i} \qquad ( 13 )$$

Here, h is an arbitrary univariate function [symbol] [symbol] [symbol] . These integrals can be efficiently computed using quadrature integration (e.g. recursive adaptive Simpson quadrature), but in some practical applications the same functions ƒᵢ in Equation (12) are used for many factors. A considerable computational efficiency enhancement can be obtained by designing integrals dedicated to some functions (in practice, using pre-computed functions with linear interpolation is 10 to 100 times faster than running a new quadrature every time). One commonly encountered example is the step function: ƒᵢ(x)= [symbol] _{{x≧0}} for all iε{1, . . . , n}. For this function and using Gaussian pivot functions as specified in Equation (11), a closed form expression is obtained in terms of normal cdf function Φ:

$${U}_{[ {𝕀}_{\{ \cdot \geq 0 \}} ]} ( α , β , p ) = \sqrt{\frac{2 π}{p α}} Φ ( β \sqrt{\frac{p}{α}} ) {e}^{\frac{p {β}^{2}}{2 α}} \qquad ( 14 )$$

where Φ is the cumulative density function of a centered normalized Gaussian random variable.

Concerning the other factor I_{g}, its log-quadratic form corresponds to a standard Gaussian integral:

$${I}_{g} ( θ ; q ) = {\int }_{{ℝ}^{n}}^{ } {e}^{- \frac{q}{2} {t}^{T} ( A - diag ( {θ}_{1} ) ) t + {q ( b - {θ}_{2} )}^{T} t} d t \qquad ( 15 )$$

which can be recast as:

I_{g}(θ;q)=N(q(A−diag(θ₁)),q(b−θ₂)) (16)

where N(A,b) is involves a matrix inversion and a determinant computation:

$$N ( A , b ) := {\int }_{{ℝ}^{n}}^{ } {e}^{- \frac{1}{2} {t}^{T} At + {b}^{T} t} d t = \frac{{( 2 π )}^{\frac{n}{2}}}{{\vert A \vert}^{\frac{1}{2}}} {e}^{\frac{1}{2} {b}^{T} {A}^{- 1} b} \qquad ( 17 )$$

Truncated multivariate Gaussian integration is next considered. Most of the truncated multivariate Gaussian integration problems with linear truncations can be put under the canonical form of Equation (10) where truncations are orthogonal, i.e. ƒᵢ(x)= [symbol] _{{x≧0}} for all iε{1, . . . , n}. Integrating truncated correlated Gaussian is a known open problem for which only approximation techniques are presently available. To be used in a learning framework, upper and lower bounds to the integral of Equation (10) are often useful. The disclosed variational Hölder's inequality approach disclosed herein is well suited to provide the upper bound.

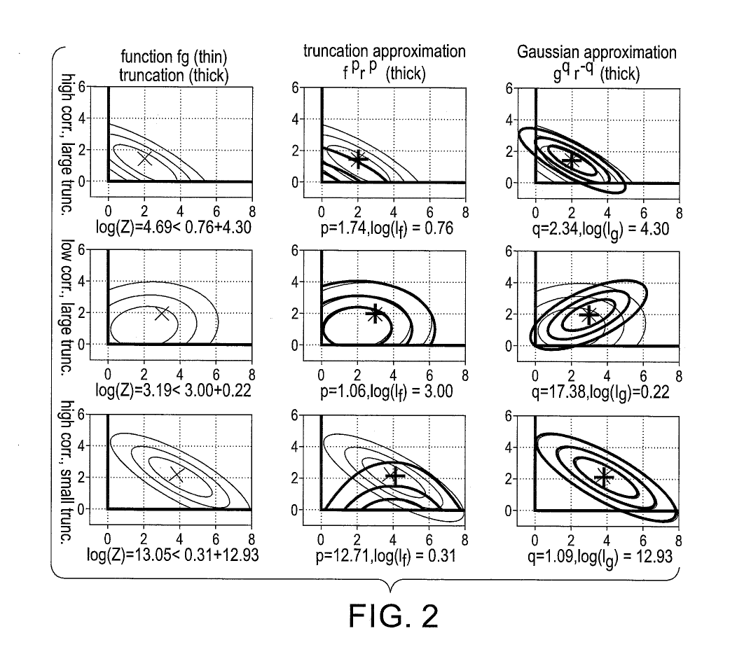

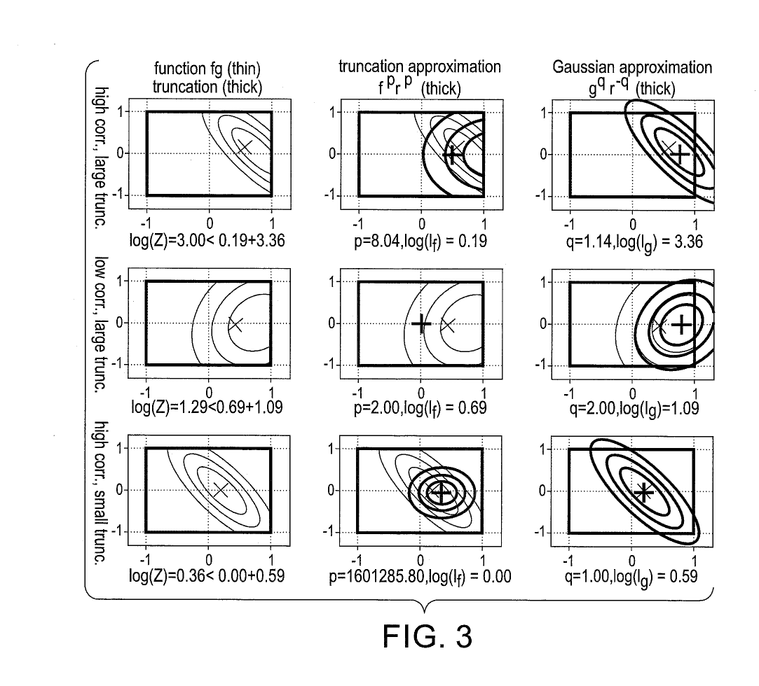

With reference to FIGS. 2 and 3, examples of truncated Gaussian integration are shown. Each row of FIGS. 2 and 3 represents a different correlation/truncation setting. The left column shows the target function ƒg. The middle column shows its first tractable approximation ƒ^{p}r^{p} (for FIG. 2 and FIG. 3) which is the product of orthogonal univariate function. The right column shows its second tractable approximation g^{q}r^{-q} (for FIG. 2 and FIG. 3) which is the correlated Gaussian distribution. Symbols ‘x’ and ‘+’ are the exact and approximate means, respectively.

Sparse probit regression is next considered. Probit regression is a Generalized Linear Model (GLM) for binary observations. In Bayesian statistics, probit regression is often preferred to logistic regression as there is a natural interpretation of the model as a multivariate truncated Gaussian variable. In fact it corresponds exactly to a truncated multivariate Gaussian integration. It is shown here that good performance for this problem can be obtained using the variational Hölder approach disclosed herein. In brief, the upper bounding technique is applied to the evidence integral to obtain tractable approximations.

Let [symbol] =(X,y), where Xε [symbol] ^{m×d} is the data matrix, i.e. Xᵢⱼ is the value of the j-th covariate for the i-th data point, and yε{−1,1}ⁿ the vector of binary output variables. We define M as the signed data matrix, such that Mᵢⱼ=yᵢXᵢⱼ. The likelihood function is p( [symbol] |w)=Πᵢ₌₁^{m}p(yᵢ|Xᵢ₁, . . . , w)=Φ(Mw) where Φ: [symbol] ™ [symbol] [0,1] is the product of normal cdfs: Φ(s)=Πᵢ₌₁^{m}∫_{-∞}^{s}^{ᵢ} [symbol] (uᵢ|0,1)duᵢ=Πᵢ₌₁^{m}∫_{-∞}⁰ [symbol] (vᵢ−sᵢ|0,1)dvᵢ= [symbol] [symbol] _{{v≧0}} [symbol] (v|s, Iₙ)dv, and where [symbol] (u|μ,Σ) is the multivariate Gaussian probability density function (pdf) with mean μ and covariance matrix E. Arbitrary uncorrelated priors ρⱼ(wⱼ) on the coefficients wⱼ are considered here. The marginal data probability (evidence) is obtained by averaging this likelihood over the prior distribution:

p( [symbol] )= [symbol] p( [symbol] |w)dp(w)= [symbol] Φ(Mw)dp(w) (18)

which can be written as:

$$p ( 𝒟 ) = {\int }_{{ℝ}^{d}}^{ } {\int }_{{ℝ}^{m}}^{ } {𝕀}_{\{ v \geq 0 \}} {\prod }_{j = 1}^{d} \frac{{p}_{j} ( {w}_{j} )}{ ( {w}_{j} \vert 0 , 1 )} ( v \vert Mw , {I}_{m} ) ( w \vert {0}_{d} , {I}_{d} ) d v d w \qquad ( 19 )$$

or more succinctly as:

$$p ( 𝒟 ) = {\int }_{{ℝ}^{d + m}}^{ } {\prod }_{i = 1}^{d + m} {f}_{i} ( {t}_{i} ) {e}^{- \frac{1}{2} {t}^{T} At} d v \qquad ( 20 )$$

where:

$$A = [ \begin{matrix}{I}_{d} & {M}^{T} \\ M & {I}_{n} + {MM}^{T}\end{matrix} ] and {f}_{i} ( {t}_{i} ) = \{ \begin{matrix}\frac{{p}_{j} ( {w}_{j} )}{ ( {w}_{j} \vert 0 , 1 )} & if i \leq d \\ {𝕀}_{\{ {t}_{i} \geq 0 \}} & otherwise\end{matrix} \qquad ( 21 )$$

The matrices Iₙ and 0_{n×d} denote the identity matrix and zero matrix of size n×n and n×d, respectively. Equation (20) is based on the concatenation t:=[w^{T}, v^{T}]^{T} and corresponds exactly the same form as Equation (10), i.e. a correlated Gaussian pdf multiplied by orthogonal n=d+m univariate functions.

The system of FIG. 1 evaluates the integral 12 of the form Z:= [symbol] ƒ(t)g(t)dv(t) in which the integrand is a product of two functions ƒ(t) and g(t). However, this can be readily generalized to an integrand which is the product of more than two factors. The extension is based on the generalized Hölder's inequality which is direct extension of the standard Hölder's inequality of Equation (1). Assume that ƒ₁, . . . , ƒ_{K} are non-negative integrable functions and v is a known probability distribution (the base measure). The integral to be evaluated is Z:= [symbol] Πₖ₌₁^{K}(t)dv(t) where K≧2. In this context, the following generalized Hölder's inequality holds:

$${\int }_{𝒯}^{ } {\prod }_{k = 1}^{K} {f}_{k} ( t ) d v ( t ) \leq {\prod }_{k = 1}^{K} {( {\int }_{𝒯}^{ } {f}_{k}^{\frac{1}{{ρ}_{k}}} ( t ) d v ( t ) )}^{{ρ}_{k}} \qquad ( 22 )$$

for any K-dimensional vector ρεΔ_{K-1} where Δ_{K-1}={ρ; ρₖ≧0, Σ^{k=1}^{^{K}}ρₖ=1} is the (K−1)-dimensional simplex. The generalized Hölder's inequality of Equation (22) is readily demonstrated by applying the standard Hölder inequality of Equation (1) recursively. By setting

$$K = 2 , p = \frac{1}{{ρ}_{1}} and q = \frac{1}{{ρ}_{2}} ,$$

Equation (1) is recovered.

The introduction of a pivot function into the generalized Hölder inequality of Equation (22) is developed as follows. Define a non-negative pivot function q(t)=Πᵢ₌₁^{K}qₖ(t). Then, the following results holds:

$${\int }_{𝒯}^{ } {\prod }_{k ′ = 1}^{K} {f}_{k} ( t ) d v ( t ) \leq {\prod }_{k = 1}^{K} {( {\int }_{𝒯}^{ } {( \frac{{f}_{k ( t )}}{{q}_{k} ( t )} )}^{\frac{1}{{ρ}_{k}}} {\prod }_{k ′ = 1}^{K} {q}_{k ′} ( t ) d v ( x ) )}^{{ρ}_{k}} \qquad ( 23 )$$

This result can be demonstrated as follows. Substituting

$$\frac{{f}_{k}}{{q}_{k}}$$

for ƒₖ and Π_{k′=1}^{K}qₖ,(t)dv(t) for dv(t) in Equation (22) leaves the left integral unchanged but gives the required right hand side of the equation. This result is also a variational Hölder inequality, since it is a direct generalization of Equation (2) for more than two factors. The function q(t) is actually a factored approximation rather than a formal pivot function, similarly to the difference between binary logistic regression (with odd-ratios) and multinomial logistic regression (with unnormalized scores). Nonetheless, the function q(t) serves the same functionality (e.g. providing a tighter bound) as does the function r(t) in Equation (2), and the function q(t) is defined as a pivot function herein.

The pivot function q(t) provides a tight bound as follows. In the following, K≧2 is assumed. (The special case of K=2 is also covered by Equation (2) and its sequel). Analogous to the Equation (5) and its surrounding discussion, if qₖ(t)=cₖƒₖ(t) for any tε [symbol] where cₖ are non-negative constants then the inequality in Equation (23) is an equality.

In Equation (23), the integral over the product is transformed into a product of integrals, each of them being potentially easier to approximate. Equation (23) can be written in a slightly different for by isolating the terms ƒₖ and qₖ, and taking the logarithm:

$$log {\int }_{𝒯}^{ } {\prod }_{k = 1}^{K} {f}_{k } ( t ) d v ( t ) \leq {\sum }_{k = 1}^{K} {ρ}_{k} log {\int }_{𝒯}^{ } {( \frac{{f}_{k ( t )}}{{q}_{k} ( t )} )}^{\frac{1}{{ρ}_{k}}} {\prod }_{k ′ = 1}^{K} {q}_{k ′} ( t ) d v ( t ) . \qquad ( 24 )$$

It is seen that this bound can be viewed as a Reverse Information Inequality by comparison directly with the standard information inequality, further assuming that q is a proper distribution function, i.e. that it sums to one:

$$log {\int }_{𝒯}^{ } {\prod }_{k = 1}^{K} {f}_{k } ( t ) d v ( t ) \geq {\sum }_{k = 1}^{K} {\int }_{𝒯}^{ } {q}_{k ′} ( t ) log {f}_{k} ( t ) d v ( t ) + ( q ) \qquad ( 25 )$$

where [symbol] (q)=−Σ_{k×1}^{K} log ƒ [symbol] Σ_{k′=1}^{K}qₖ,(t)log qₖ(t)dv(t) is the entropy of q.

In analogy to the K=2 embodiment shown in FIG. 1, the result of minimizing the upper bound of Equation (23) respective to the pivot function q(t) is an optimized pivot function qₒₚₜ(t) consisting of optimized elements q₁_{ₒₚₜ}(t), . . . , q_{K}_{ₒₚₜ}(t) and the optimized K-dimensional vector ρₒₚₜ consisting of optimized components ρ₁_{ₒₚₜ}, . . . , ρ_{K}_{ₒₚₜ}. The integral is then evaluated as

$$Z ≅ {\prod }_{k = 1}^{K} {( {\int }_{𝒯}^{ } {( \frac{{f}_{k} ( t )}{{q}_{k} ( t )} )}^{\frac{1}{{ρ}_{k}}} {\prod }_{k ′ = 1}^{K} {q}_{k ′} ( t ) d v ( x ) )}^{{ρ}_{k}}$$

with q(t)=qₒₚₜ(t) and ρ=ρₒₚₜ.

The disclosed variational inference approaches are fundamentally different from other inference techniques commonly used in Bayesian inference. It has the advantage of being scalable, i.e. it leads to a convex problem that can be efficiently optimized, thus reducing the computational resources required to perform the integration. There are diverse applications in data analytics where Bayesian inference is used to advantages, including by way of example: factorization methods, as used in customer care to profile users and agents, or in education analytics, where the performances of the student are measured based on a lot of random exam assignment. Another area of application is transportation analytics to recover the trajectory of a user based on partial location information (such as the location of the ticket validations): the recovery of the user home location cannot be perfect, but a distribution over the possible locations can be inferred.

The disclosed variational integral approximations are based on minimization of an upper bound to a log-partition function. The disclosed variational inference problem is convex if the variational function is log-linear, which has practical and theoretical advantages. Application to handling sparse regression in GLMs, e.g. using probit regression (but the extension to other losses is straightforward) is described as an illustrative application. Advantageously, a convex objective is maintained even if the sparse factors exhibit heavy tails.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A non-transitory storage medium storing instructions readable and executable by an electronic data processing device to perform a method of evaluating an integral Z:= [symbol] Πᵢ₌₁^{K}ƒₖ(t)dv(t) where K≧2, v is a measure on a space [symbol] and ƒₖ(t), k=1, . . . , K are functions defined in the space [symbol] , the method comprising operations including:
optimizing a pivot function q(t)=Πₖ₌₁^{K}qₖ(t) to minimize a bound defined by the inequality:
$${\int }_{𝒯}^{ } {\prod }_{k ′ = 1}^{K} {f}_{k} ( t ) d v ( t ) \leq {\prod }_{k = 1}^{K} {( {\int }_{𝒯}^{ } {( \frac{{f}_{k} ( t )}{{q}_{k} ( t )} )}^{\frac{1}{{ρ}_{k}}} {\prod }_{k ′ = 1}^{K} {q}_{k ′} ( t ) d v ( x ) )}^{{ρ}_{k}}$$
where ρₖ≧0 for k=1, . . . , K and Σₖ₌₁^{K}ρ=1 to determine an optimized pivot function qₒₚₜ(t) and optimized values ρ₁_{ₒₚₜ}, . . . , ρ_{K}_{ₒₚₜ}; and
evaluating Z as the product
$${\prod }_{k = 1}^{K} {( {\int }_{𝒯}^{ } {( \frac{{f}_{k} ( t )}{{q}_{k} ( t )} )}^{\frac{1}{{ρ}_{k}}} {\prod }_{k ′ = 1}^{K} {q}_{k ′} ( t ) d v ( x ) )}^{{ρ}_{k}}$$
with q(t)=qₒₚₜ(t) and ρₖ=ρₖ_{ₒₚₜ} for k=1, . . . , K.

2. The non-transitory storage medium of claim 1 wherein
$$K = 2 , p = \frac{1}{{ρ}_{1}} , q = \frac{1}{{ρ}_{2}} , r ( t ) = {{q}_{1} ( t )}^{- \frac{1}{q}} {{q}_{2} ( t )}^{\frac{1}{p}} ,$$
the optimizing comprises optimizing the pivot function r(t) to minimize a bound defined by the inequality:
$$Z \leq {( {\int }_{𝒯}^{ } {f ( t )}^{p} {r ( t )}^{p} d v ( t ) )}^{\frac{1}{p}} {( {\int }_{𝒯}^{ } {g ( t )}^{q} {r ( t )}^{- q} d v ( t ) )}^{\frac{1}{q}}$$
to generate an optimized pivot function rₒₚₜ(t) and optimized values pₒₚₜ and qₒₚₜ, and the evaluating comprises evaluating Z as the product
$${( {\int }_{𝒯}^{ } {f ( t )}^{{p}_{opt}} {{r}_{opt} ( t )}^{{p}_{opt}} d v ( t ) )}^{\frac{1}{{p}_{opt}}} {( {\int }_{𝒯}^{ } {g ( t )}^{{q}_{opt}} {{r}_{opt} ( t )}^{- {q}_{opt}} d v ( t ) )}^{\frac{1}{{q}_{opt}}} .$$

3. The non-transitory storage medium of claim 2 wherein the pivot function r(t)=r(•,θ) where θ is a set of parameters, the optimizing comprises optimizing the set of parameters θ to generate a set of optimized parameters θₒₚₜ defining rₒₚₜ(t)=r(•,θₒₚₜ).

4. The non-transitory storage medium of claim 3 wherein the optimizing comprises minimizing
$$log \overline{I} ( θ ) := \frac{1}{p} log {I}_{f} ( θ ; p ) + \frac{1}{q} log {I}_{g} ( θ ; q )$$
with respect to θ and at least one of p and q, where I_{ƒ}= [symbol] ƒ(t)^{p}r(t)^{p}dv(t) and I_{g}= [symbol] g(t)^{q}r(t)^{-q}dv(t).

5. The non-transitory storage medium of claim 2 wherein the pivot function r(t) is a log-linear function whereby the bound defined by the inequality is log-convex.

6. The non-transitory storage medium of claim 5 wherein the pivot function r(t,θ)=e^{<θ,φ(t)>} where θεΘ and φ: [symbol] [symbol] Θ defines a feature function.

7. The non-transitory storage medium of claim 2 further storing instructions executable by the electronic data processing device to evaluate the distribution ƒg as one of ƒg=ƒ^{p}rₒₚₜ^{p} and ƒg=g^{q}rₒₚₜ^{-q}.

8. The non-transitory storage medium of claim 2 wherein:
$$Z = {\int }_{{ℝ}^{n}}^{ } {\prod }_{i = 1}^{n} {f}_{i} ( {t}_{i} ) {e}^{- \frac{1}{2} {t}^{T} At + {b}^{T} t} d t$$
and ƒ(t)=Πᵢ₌₁ⁿƒᵢ(tᵢ) where each function ƒᵢ: [symbol] [symbol] [symbol] is univariate and
$$g ( t ) = {\prod }_{i = 1}^{n} {e}^{- \frac{1}{2} {t}^{T} At + {b}^{T} t}$$
where A is a symmetric n×n matrix and bε [symbol] ⁿ and:
$$r ( t ; θ ) := {e}^{- \frac{1}{2} {t}^{T} diag ( {θ}_{1} ) t + {\tilde{θ}}_{2}^{T} t} , θ = {( {θ}_{1}^{T} , {θ}_{2}^{T} )}^{T} , {θ}_{1} ∈ {ℝ}^{n} , {θ}_{2} ∈ {ℝ}^{n}$$
and wherein the optimizing comprises optimizing the set of parameters θ to generate a set of optimized parameters θₒₚₜ defining rₒₚₜ(t).

9. An apparatus comprising:
a non-transitory storage medium as set forth in claim 1; and
an electronic data processing device configured to read and execute the instructions stored on the non-transitory storage medium.

10. A method operating on two functions ƒ and g each mapping from a space [symbol] into [symbol] ⁺, the method comprising:
optimizing a pivot function r: [symbol] [symbol] [symbol] ⁺ to minimize a bound defined by the inequality:
$$Z \leq {( {\int }_{𝒯}^{ } {f ( t )}^{p} {r ( t )}^{p} d v ( t ) )}^{\frac{1}{p}} {( {\int }_{𝒯}^{ } {g ( t )}^{q} {r ( t )}^{- q} d v ( t ) )}^{\frac{1}{q}} .$$
where v is a measure on the space [symbol] and p≧1 and
$$\frac{1}{p} + \frac{1}{q} = 1$$
to determine an optimized pivot function rₒₚₜ(t);
wherein the optimizing is performed by an electronic data processing device.

11. The method of claim 10 further comprising:
evaluating the product ƒg as one of ƒg=ƒ^{p}rₒₚₜ^{p} and ƒg=g^{q}rₒₚₜ^{-q} wherein the evaluating is performed by the electronic data processing device.

12. The method of claim 11 wherein the optimizing also optimizes p and q to generate optimized values pₒₚₜ and qₒₚₜ respectively, and the evaluating comprises evaluating the product ƒg as one of ƒg=ƒ^{p}^{ₒₚₜ}rₒₚₜ^{p}^{ₒₚₜ} and ƒg=g^{q}^{ₒₚₜ}rₒₚₜ^{-q}^{ₒₚₜ}.

13. The method of claim 10 further comprising:
evaluating the integral Z:= [symbol] ƒ(t)g(t)dv(t) as the product
$${( {\int }_{𝒯}^{ } {f ( t )}^{p} {r ( t )}^{p} d v ( t ) )}^{\frac{1}{p}} {( {\int }_{𝒯}^{ } {g ( t )}^{q} {r ( t )}^{- q} d v ( t ) )}^{\frac{1}{q}}$$
with r(t)=rₒₚₜ(t);
wherein the evaluating is performed by the electronic data processing device.

14. The method of claim 13 wherein the optimizing also optimizes p and q to generate optimized values pₒₚₜ and qₒₚₜ respectively, and the evaluating comprises evaluating the product
$${( {\int }_{𝒯}^{ } {f ( t )}^{p} {r ( t )}^{p} d v ( t ) )}^{\frac{1}{p}} {( {\int }_{𝒯}^{ } {g ( t )}^{q} {r ( t )}^{- q} d v ( t ) )}^{\frac{1}{q}}$$
with r(t)=rₒₚₜ(t) and p=pₒₚₜ and q=qₒₚₜ.

15. The method of claim 13 wherein the pivot function r(t)=r(•,θ) where θ is a set of parameters, the optimizing comprises optimizing the set of parameters θ to generate a set of optimized parameters θₒₚₜ defining rₒₚₜ(t)=r(•,θₒₚₜ).

16. The method of claim 15 wherein the optimizing comprises minimizing
$$log \overline{I} ( θ ) := \frac{1}{p} log {I}_{f } ( θ ; p ) + \frac{1}{q} log {I}_{g} ( θ ; q )$$
with respect to θ.

17. The method of claim 15 wherein the pivot function r(t) is a log-linear function.

18. The method of claim 15 wherein the pivot function r(t,θ)=e^{<θ,φ(t)>} where θεΘ and φ: [symbol] [symbol] Θ.

19. The method of claim 13 wherein:
$$Z = {\int }_{{ℝ}^{n}}^{ } {\prod }_{i = 1}^{n} {f}_{i} ( {t}_{i} ) {e}^{- \frac{1}{2} {t}^{T} At + {b}^{T} t} d t$$
and ƒ(t)=Πᵢ₌₁ⁿƒᵢ(tᵢ) where each function ƒᵢ= [symbol] [symbol] [symbol] is univariate and
$$g ( t ) = {\prod }_{i = 1}^{n} {e}^{- \frac{1}{2} {t}^{T} At + {b}^{T} t}$$
where A is a symmetric n×n matrix and bε [symbol] ⁿ.

20. The method of claim 19 wherein the pivot function is:
$$r ( t ; θ ) := {e}^{- \frac{1}{2} {t}^{T} diag ( {θ}_{1} ) t + {θ}_{2}^{T} t} , θ = {( {θ}_{1}^{T} , {θ}_{2}^{T} )}^{T} , {θ}_{1} ∈ {ℝ}^{n} , {θ}_{2} ∈ {ℝ}^{n}$$
and the optimizing comprises optimizing the set of parameters θ to generate a set of optimized parameters θₒₚₜ defining rₒₚₜ(t).
